(19) United States
(12) Patent Application Publication
(10) Pub. No.: US 2013/0282441 A1
(43) Pub. Date: Oct. 24, 2013

(54) SYSTEMS AND METHODS FOR ESTIMATING COST OF SYSTEM TESTING REQUEST BASED ON TABLE UNIT

(71) Applicant: INFOSYS LIMITED, Bangalore (IN)

(72) Inventors: Ravi Agarwal, Pune (IN); Neetu Kumar, Pune (IN); Vishwadeep Singh, Pune (IN); Chandana Oak, Pune (IN)

(73) Assignee: Infosys Limited, Bangalore (IN)

(21) Appl. No.: 13/865,581

(22) Filed: Apr. 18, 2013

(30) Foreign Application Priority Data
Apr. 18, 2012 (IN) 1537/CHE/2012

(51) Int. Cl. G06Q 30/02

(52) U.S. Cl. CPC G06Q 30/0206
USPC 705/7.35

(57) ABSTRACT

The invention relates to a system and method for estimating a cost for one or more system testing request in a data warehouse environment for a client based on a single table unit. This invention uses the past data of the client requests to derive the single table unit. It classifies the tables impacted in the past client requests into simple, medium and complex. It also derives simple table ratio, medium table ratio and complex table ratio. Thereafter, the tables of different complexities are converted into single table unit based on the simple table ratio, medium table ratio and complex table ratio. Finally, the cost is estimated in terms of single table unit based on the past data.

### RELATED APPLICATION DATA

This application claims priority to Indian Patent Application No. 1537/CHE/2012, filed Apr. 18, 2012, which is hereby incorporated by reference in its entirety.

### FIELD OF THE INVENTION

The invention relates generally to the field of estimating cost for system testing request. In particular, the present invention relates to a system and method for estimating cost of system testing request based on table unit in a data warehouse environment.

### BACKGROUND

Testing is performed to find out defects in the system and in other words to prevent a defective product from reaching to the customer. It also ensures that the product confirms the specification and the functionality agreed to with the client. Of late, the significance of software testing rises so much that the importance of an independent entity, i.e. the entity not involved in the development of the software, to test the software is increasingly being recognized. And thus, estimating the test effort becomes very important to charge the client for the testing work. The present unit based estimation models for testing databases or data warehouses are typically request based or test case based.

In case of request based estimation the cost is determined based on the number of requests and in case of test case based estimation the cost is estimated based on the number of test cases against which the testing is performed. There are drawbacks in both the models. For estimation where unit is a request, the estimation would not be very accurate since a request can comprises of tables having different complexities. Hence, estimates have to be derived taking an average complexity of all the tables. Similarly, for test case based unit estimation, there could be an argument on the number of test cases needed to have hundred percent test coverage.

In view of the foregoing discussion, there is a need for a cost estimation method of testing which is not dependent on number of test cases and also very accurate in terms of tables involved in the testing project.

### SUMMARY

The present invention overcomes the above mentioned drawbacks by taking into account the unit of estimation as a table. Hence, the overall estimate would be the sum of individual table estimates which would be more accurate and also independent of number of test cases.

According to the present embodiment, a method for estimating a cost for one or more system testing request in a data warehouse environment for a client based on a single table unit is disclosed. The method includes collecting past data of one or more requests of the client for testing. From the past data one or more tables of different complexities are identified. Then, an effort required to test the one or more tables of different complexities is estimated. This effort is estimated based on a time required to test the one or more tables of different complexities. After that, the one or more tables are converted into the single table unit based on the effort required to test the one or more tables of different complexities. Subsequently, the cost for testing the single table unit is estimated based on the past data of the client.

In an additional embodiment, a system for estimating a cost for one or more system testing request in a data warehouse environment for a client based on a single table unit is disclosed. As disclosed, the embodiment includes a data collection module, a table complexity identification module, an effort estimation module, a table unit conversion module and a cost estimation module. The data collection module is configured for collecting past data of one or more requests of the client for testing, the table complexity identification module is configured for identifying one or more tables of different complexities from the past data, the effort estimation module is configured for estimating an effort required to test the one or more tables of different complexities, the table unit conversion module is configured to convert the one or more tables into the single table unit based on the effort required to test the one or more tables of different complexities and the cost estimation module is configured for estimating the single table unit based on the past data.

In another embodiment, a computer program product for estimating a cost for one or more system testing request in a data warehouse environment for a client based on a single table unit is disclosed. The computer program product includes a computer usable medium having a computer readable program code embodied therein for estimating a cost for one or more system testing request in a data warehouse environment for a client based on a single table unit. The computer readable program code storing a set of instructions configured for collecting past data of one or more requests of the client for testing, identifying one or more tables of different complexities from the past data, estimating an effort required to test the one or more tables of different complexities, converting the one or more tables into the single table unit based on the effort required to test the one or more tables of different complexities and estimating the cost for testing the single table unit based on the past data.

### DRAWINGS

Various embodiments of the invention will, hereinafter, be described in conjunction with the appended drawings provided to illustrate, and not to limit the invention, wherein like designations denote like elements, and in which:

FIG. 1 is a computer architecture diagram illustrating a computing system capable of implementing the embodiments presented herein.

FIG. 2 is a flowchart, illustrating a method for estimating a cost for one or more system testing request in a data warehouse environment for a client based on a single table unit, in accordance with an embodiment of the present invention.

FIG. 3 is a block diagram illustrating a system for estimating a cost for one or more system testing request in a data warehouse environment for a client based on a single table unit, in accordance with an embodiment of the present invention.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

Exemplary embodiments of the present disclosure provides a system and method for estimating a cost for one or more system testing request in a data warehouse environment for a client, based on a single table unit, where past data of one or more requests for testing of the client is collected and analyzed. From the past data one or more tables of different complexities are identified and based on the one or more tables an effort required to test the one or more tables is estimated. The one or more tables are converted to a single table unit to estimate the cost of testing.

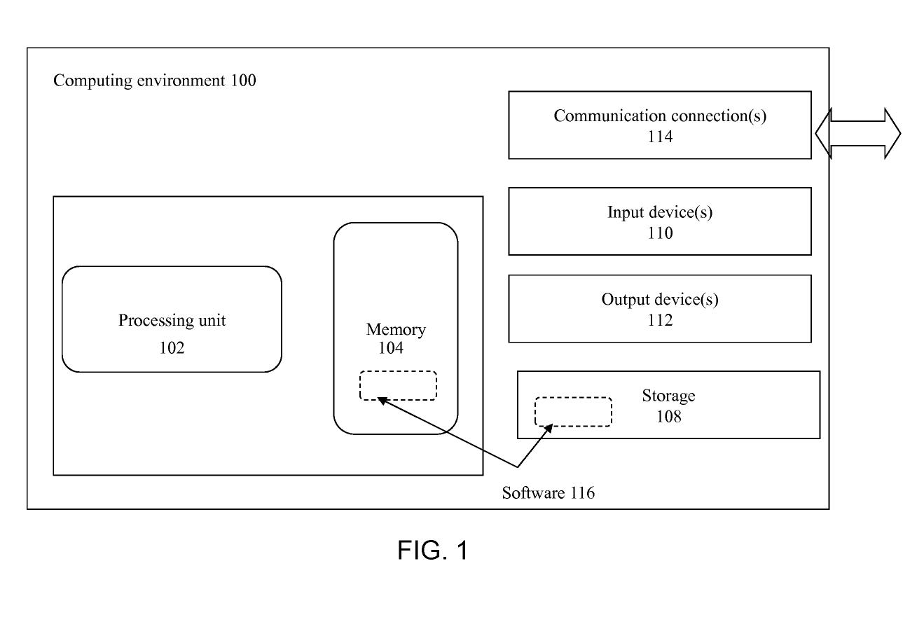

FIG. 1 illustrates a generalized example of a suitable computing environment 100 in which all embodiments, techniques, and technologies of this invention may be implemented. The computing environment 100 is not intended to suggest any limitation as to scope of use or functionality of the technology, as the technology may be implemented in diverse general-purpose or special-purpose computing environments. For example, the disclosed technology may be implemented using a computing device (e.g., a server, desktop, laptop, hand-held device, mobile device, PDA, etc.) comprising a processing unit, memory, and storage storing computer-executable instructions implementing the service level management technologies described herein. The disclosed technology may also be implemented with other computer system configurations, including hand held devices, multiprocessor systems, microprocessor-based or programmable consumer electronics, network PCs, minicomputers, mainframe computers, a collection of client/server systems, and the like.

With reference to FIG. 1, the computing environment 100 includes at least one central processing unit 102 and memory 104. The central processing unit 102 executes computer-executable instructions. In a multi-processing system, multiple processing units execute computer-executable instructions to increase processing power and as such, multiple processors can be running simultaneously. The memory 104 may be volatile memory (e.g., registers, cache, RAM), non-volatile memory (e.g., ROM, EEPROM, flash memory, etc.), or some combination of the two. The memory 104 stores software 116 that can implement the technologies described herein. A computing environment may have additional features. For example, the computing environment 100 includes storage 108, one or more input devices 110, one or more output devices 112, and one or more communication connections 114. An interconnection mechanism (not shown) such as a bus, a controller, or a network, interconnects the components of the computing environment 100. Typically, operating system software (not shown) provides an operating environment for other software executing in the computing environment 100, and coordinates activities of the components of the computing environment 100.

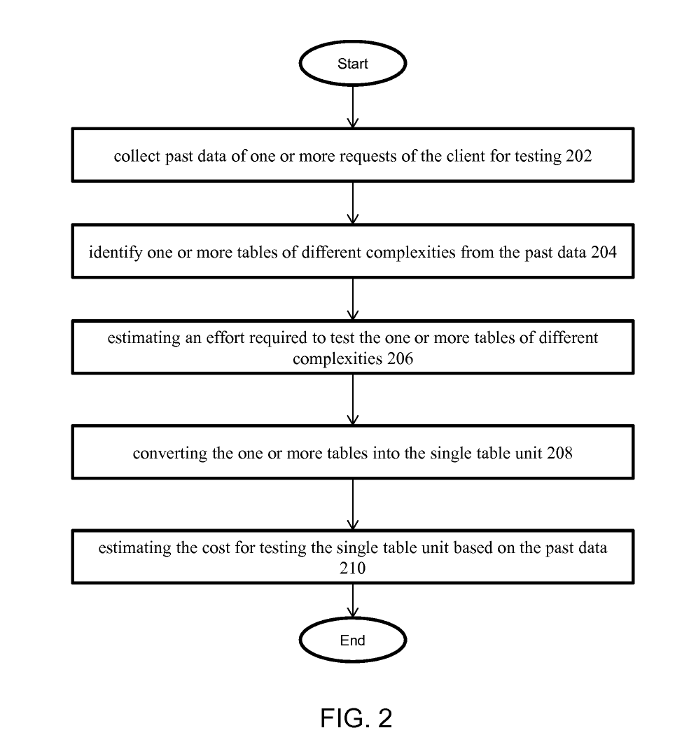

FIG. 2 is a flowchart, illustrating a method for estimating a cost for one or more system testing request in a data warehouse environment for a client based on a single table unit. The method includes, collecting past data or historical data of one or more requests of the client for testing, as shown in block 202. These records can be collected from past records of the client. The past data may include number of tables contained in the past client request, total time required to complete each request, i.e. effort estimation details and an amount of money charged to the client for each request. Thereafter, the complexity of the one or more tables contained in the client request is identified, as in block 204. The one or more tables can be classified as simple, medium and complex based upon certain criteria to determine the complexity. The criteria include number of source files for a table, a number of modifications to the table and a number of fields in the table. To determine the complexity of one table, the number of source files/table and the number of modifications to the table are required to consider at first. Based on that analysis different parameters e.g. X, Y and Z can be determined. The determination of these parameters is case sensitive. An exemplary table for determining parameters X, Y and Z may be as follows:

TABLE 1
Criteria 1

| | No. of Source | | |
|---|---|---|---|
| | Files/Table | | |
| No. of Modifications | =1 | =3 | >3 |
| <=2 | X | Y | Y |
| >2 and <=4 | X | Y | Z |
| >4 and <=6 | Y | Z | Z |

In the above table, if the number of source files/table is equal to 1 and number of modifications are less than equal to 2 or if the number of source files/table is equal to 1 and number of modifications are greater than 2 and less than equal to 4, then the parameter will be X. Again, if the number of source files/table is equal to 3 or greater than 3 and number of modifications are less than equal to 2 or if the number of source files/table is equal to 3 and number of modifications are greater than 2 and less than equal to 4 then the parameter will be Y. Similarly, if the number of source files/table is equal to 1 and number of modifications is greater than 4 and less than equal to 6, then the parameter will be Y. Again, if the number of source files/table is greater than 3 and number of modifications is greater than 2 and less than equal to 4, then the parameter will be Z. Similarly, if the number of source files/table is equal to 3 or greater than 3 and number of modifications are greater than 4 and less than equal to 6 then the parameter will be Z. Thus, the above table is a function of source files/table and the number of modifications to the table.

The complexity of the table can be determined by analyzing the above mentioned parameters in combination with the number of fields in the table. An exemplary table to determine the complexity based on the above mentioned parameters and the number of fields in the table may be as follows:

TABLE 2

| | No. of Fields in the Table | | |
|---|---|---|---|
| Criteria 1 Result | <=9 | >9 and <=15 | >15 and <=25 |
| X | S | M | M |
| Y | S | M | C |
| Z | S | C | C |

In the above table the criteria 1 result of Table 1 is combined with the number of fields in the table to determine the complexity of the table in the form of simple (S), medium (M) and complex (C). According to the table 2, if the parameter of the table is X or Y or Z and the number of fields in the table is less than equal to 9, then the complexity of the table will be simple (S). if the parameter of the table is X or Y and number of fields in the table is greater than 9 and less than equal to 15, then the complexity of the table will be medium (M). Again, if the parameter of the table is X and number of fields in the table is greater than 15 and less than equal to 25, then complexity of the table will be medium (M). Further, if the parameter of the table is Y and number of fields in the table is greater than 15 and less than equal to 25, then complexity of the table will be complex (C). Similarly, if the parameter of the table is Z and the number of fields in the table is greater than 9 and less than equal to 15 or greater than 15 and less than equal to 25, then the complexity of the table will be complex (C).

Referring back to FIG. 2, the effort required to test the one or more tables of different complexities are estimated, as in block 206. The effort is estimated based on a time required to test the one or more tables of different complexities in the past testing requests of the client. The effort required for testing the one or more table of different complexities of each of the client request may be represented as follows:

TABLE 3

| | | | | | Amount of |
|---|---|---|---|---|---|
| | | | | Total Hours | money |
| Request | Number | | | required in | charged to the |
| number | of | Number of | Number of | past to | client in a |
| of the | Simple | Medium | Complex | complete | particular |
| client | Table | Table | table | the testing | currency |
| R1 | 1 | 1 | 0 | 30 | 100 |
| R2 | 3 | 0 | 0 | 25 | 200 |
| R3 | 2 | 0 | 0 | 30 | 300 |
| R4 | 10 | 0 | 0 | 96 | 400 |
| R5 | 0 | 0 | 4 | 330 | 450 |
| R6 | 1 | 2 | 2 | 440 | 500 |
| R7 | 45 | 1 | 1 | 31 | 550 |
| R8 | 4 | 6 | 11 | 25 | 600 |
| R9 | 14 | 1 | 5 | 3159 | 650 |
| R10 | 6 | 5 | 5 | 556 | 700 |
| Total | 86 | 16 | 28 | 4722 | 4450 |

The above table can be used as framework for calculating table based unit pricing. The total number of simple table, total number of medium table, total number of complex table, total hours required in past to complete the testing and total amount of money charged to the client in a particular currency are determined. According to the table 3, total 4722 hours were required in past to complete 86 simple tables, 16 medium tables and 28 complex tables. Thus, 86 simple tables, 16 medium tables and 28 complex tables are equivalent to 4722 hours. This can be expressed by the following mathematical formula:

S(x)+M(y)+C(z)=H

In the above formula, S is the total number of simple table, M is the total number of medium table, C is the total number of complex table, H is the total hours required in past to complete the total number of simple, medium and complex table, x is the simple ratio, y is the medium ratio and z is the complex ratio. Trial and error method is used to determine the x, y and z. The trial and error method can be initiated by estimating effort expanded to requests only consisting of simple table or medium table or complex table. Thus, the above mentioned mathematical formula can be expressed in terms of x, as follows:

H=S(x)+M(f(x))+C(f(x))

In this way, the value of x, y and z is determined. After determining the value of x, y and z, these data is used in any two or more sets of table 3 to get the accuracy of the value. Further, a correlation check is carried out to determine the accuracy of the values. If the value of the correlation check is within a preferred range, then the value of x, y and z can be considered for the rest of the steps of this disclosure. An example of the preferred range for the Table 3 may include but not limited to, is 4722±5.

The one or more tables are converted into the single table unit based on the effort required to test the one or more tables of different complexities, as in block 208. The derived value of x, y and z can be considered as units for simple table, medium table and complex table respectively. Thus, an exemplary single table unit for simple, medium and complex table may be as follows, if the value of x is 1, value of y is 1.9 and value of z is 3.5:

TABLE 4

| Table | Time required to | |
|---|---|---|
| Complexity | test the tables | Unit |
| Simple | 22 | 1 |
| Medium | 42 | 1.9 |
| Complex | 77 | 3.5 |

Now, the Table 1 and table 2 data can be merged based on the Table 4 data as follows:

TABLE 5
Units/Table

| | No. of Source Files/Table | | | | | | | | |
|---|---|---|---|---|---|---|---|---|---|
| | No. of Modifications | | | | | | | | |
| | =1 | | | =3 | | | >3 | | |
| No. of Fields | | >9 and | >15 and | | >9 and | >15 and | | >9 and | >15 and |
| in the Table | <=9 | <=15 | <=25 | <=9 | <=15 | <=25 | <=9 | <=15 | <=25 |
| <=2 | 1 | 1.9 | 1.9 | 1 | 1.9 | 1.9 | 1 | 1.9 | 3.5 |
| >2 and <=4 | 1 | 1.9 | 1.9 | 1 | 1.9 | 3.5 | 1.9 | 3.5 | 3.5 |
| >4 and <=6 | 1 | 1.9 | 3.5 | 1.9 | 3.5 | 3.5 | 1.9 | 3.5 | 3.5 |

In the Table 5, the simple table, medium table and complex table are converted into table units. Now, the cost for testing the single table unit is estimated based on the past data, as in block 210. For estimating cost, the total units to be tested are estimated based on the single table unit already derived in the earlier step. For an example, which doesn't limit the scope of the invention, the cost estimation can be done by combining the result of table 3 and 4, where the total unit tested is: (total number of simple table*1)+(total number of medium table*1.9)+(total number of complex table*3.5) which can be expressed as (86*1)+(16*1.9)+(28*3.5)≈215. Now, the total time required to complete the testing of 215 units is divided by the total number of unit tested to estimate the cost for testing the single table unit i.e. 4722/215=21.96. Thus, the amount to be charged from the client will be in terms of single table unit.

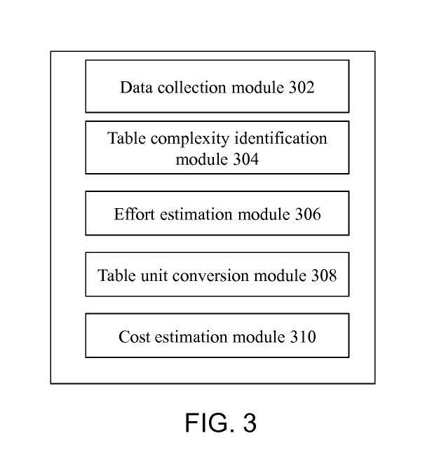

FIG. 3 is a block diagram illustrating a system for estimating a cost for one or more system testing request in a data warehouse environment for a client based on a single table unit. More particularly, in FIG. 3, system includes a data collection module 302, a table complexity identification module 304, an effort estimation module 306, a table unit conversion module 308 and a cost estimation module 310. The data collection module 302 is configured for collecting past data of one or more requests of the client for testing. The past data may include number of tables contained in the past client request, total time required to complete each request, i.e. effort estimation details and an amount of money charged to the client for each past request. The table complexity identification module 304 is configured for identifying one or more tables of different complexities from the past data. The one or more tables can be classified as simple, medium and complex based upon certain criteria to determine the complexity. The criteria include number of source files for a table, a number of modifications to the table and a number of fields in the table. To determine the complexity of one table, the number of source files/table and the number of modifications to the table are required to consider at first. Based on that analysis different parameters e.g. X, Y and Z can be determined. The complexity of the table can be determined by analyzing the above mentioned parameters (X, Y and Z) in combination with the number of fields in the table. The effort estimation module 306 is configured to estimate an effort required to test the one or more tables of different complexities. The effort is estimated based on a time required to test the one or more tables of different complexities. After that, The total number of simple table, total number of medium table, total number of complex table, total hours required in past to complete the testing and total amount of money charged to the client in a particular currency are determined. Then, to estimate the effort the following mathematical formula is used:

S(x)+M(y)+C(z)=H

In the above formula, S is the total number of simple table, M is the total number of medium table, C is the total number of complex table, H is the total hours required in past to complete the total number of simple, medium and complex table, x is the simple ratio, y is the medium ratio and z is the complex ratio. Trial and error method is used to determine the x, y and z. The trial and error method can be initiated by estimating effort expanded to requests only consisting of simple table or medium table or complex table. Thus, the above mentioned mathematical formula can be expressed in terms of x, as follows:

H=S(x)+M(f(x))+C(f(x))

In this way, the value of x, y and z is determined. Further, a correlation check is carried out to determine the accuracy of the values. If the value of the correlation check is within a preferred range, then the value of x, y and z can be considered for the rest of the steps of this disclosure.

Referring back to, the table unit conversion module 308 is configured for converting the one or more tables into the single table unit based on the effort required to test the one or more tables of different complexities. The derived value of x, y and z can be considered as units for simple table, medium table and complex table respectively. The cost estimation module 310 is configured for estimating the cost for testing the single table unit based on the past data. For estimating cost, the total units to be tested are estimated based on the single table unit already derived in the earlier step. To estimate the cost for testing, the total time required to complete the total unit tested in past is divided by the total unit tested in past.

The above mentioned description is presented to enable a person of ordinary skill in the art to make and use the invention and is provided in the context of the requirement for obtaining a patent. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

What is claimed is:

1. A computer implemented method executed by one or more computing devices for estimating a cost for one or more system testing request in a data warehouse environment for a client based on a single table unit comprising:
collecting past data of one or more requests of the client for testing;
identifying one or more tables of different complexities from the past data;
estimating an effort required to test the one or more tables of different complexities;
converting the one or more tables into the single table unit based on the effort required to test the one or more tables of different complexities; and
estimating the cost for testing the single table unit based on the past data.

2. The method as claimed in claim 1, wherein the one or more tables comprises one or more simple tables, one or more medium tables and one or more complex tables.

3. The method as claimed in claim 1, wherein the past data comprises a number of the one or more tables of different complexities contained in the one or more requests, the effort required for completing the one or more requests of the client and an amount of money charged to the client for testing each of the one or more requests.

4. The method as claimed in claim 1, wherein the complexities of the one or more tables are determined based on a plurality of criteria.

5. The method as claimed in claim 4, wherein the plurality of criteria comprise a number of source files for a table, a number of modifications to the table and a number of fields in the table.

6. The method as claimed in claim 1, wherein the effort is estimated based on a time required to test the one or more tables of different complexities.

7. The method as claimed in claim 1, wherein the cost for testing the single table unit is estimated based on a total number of the one or more tables of different complexities and a total amount of money charged to the client in the past for testing the one or more requests.

8. A system for estimating a cost for one or more system testing request in a data warehouse environment for a client based on a single table unit comprising:
a processor in operable communication with a processor readable storage medium, the processor readable storage medium containing one or more programming instructions whereby the processor is configured to implement:
a data collection module configured to collect past data of one or more requests of the client for testing;
a table complexity identification module configured to identify one or more tables of different complexities from the past data;
an effort estimation module configured to estimate an effort required to test the one or more tables of different complexities;
a table unit conversion module configured to convert the one or more tables into the single table unit based on the effort required to test the one or more tables of different complexities; and
a cost estimation module configured to determine the price for testing the single table unit based on the past data.

9. The system as claimed in claim 8, wherein the one or more tables comprises one or more simple tables, one or more medium tables and one or more complex tables.

10. The system as claimed in claim 8, wherein the past data comprises a number of the one or more tables of different complexities contained in the one or more requests, the effort required for completing the one or more requests of the client and an amount of money charged to the client for testing each of the one or more requests.

11. The system as claimed in claim 8, wherein the different complexities of the one or more tables are determined based on a plurality of criteria.

12. The system as claimed in claim 11, wherein the plurality of criteria comprise a number of source files for a table, a number of modifications to the table and a number of fields in the table.

13. The system as claimed in claim 8, wherein the effort is estimated based on a time required to test the one or more tables of different complexities.

14. The system as claimed in claim 8, wherein the cost for testing the single table unit is estimated based on a total number of the one or more tables of different complexities and a total amount of money charged to the client in the past for testing the one or more requests.

15. A computer program product for use with a computer, the computer program product comprising a computer readable medium having computer readable program code embodied therein for estimating a cost for one or more system testing request in a data warehouse environment for a client based on a single table unit, the computer readable program code storing a set of instructions configured for:
collecting past data of one or more requests of the client for testing;
identifying one or more tables of different complexities from the past data;
estimating an effort required to test the one or more tables of different complexities;
converting the one or more tables into the single table unit based on the effort required to test the one or more tables of different complexities; and
estimating the cost for testing the single table unit based on the past data.

16. The computer program product as claimed in claim 15, wherein the one or more tables comprises one or more simple tables, one or more medium tables and one or more complex tables.

17. The computer program product as claimed in claim 15, wherein the past data comprises a number of the one or more tables of different complexities contained in the one or more requests, the effort required for completing the one or more requests of the client and an amount of money charged to the client for testing each of the one or more requests.

18. The computer program product as claimed in claim 15, wherein the effort is estimated based on a time required to test the one or more tables of different complexities.

19. The computer program product as claimed in claim 15, wherein the cost for testing the single table unit is estimated based on a total number of the one or more tables of different complexities and a total amount of money charged to the client in the past for testing the one or more requests.
